(19) United States
(12) Patent Application Publication
(10) Pub. No.: US 2003/0100363 A1
(43) Pub. Date: May 29, 2003

(54) Method and apparatus for inputting appearance of computer operator into a computer program

(76) Inventor: Guiseppe C. Ali, Tucson, AZ (US)

Correspondence Address: Michael S. Neustel, Suite No. 4, 2534 South University Drive, Fargo, ND, 58103, US

(21) Appl. No.: 09/997,042

(22) Filed: Nov. 28, 2001

(51) Int. Cl. A63F 13/00

(52) U.S. Cl. 463/30; 463/31; 463/36; 463/37

(57) ABSTRACT

A method and apparatus for inputting appearance of computer operator into a computer program for inserting the appearance of the computer operator in a computer program such as a computer game or instructional program. A digital image of a computer game player's face, clothing and general body appearance is adapted to the program character to be enjoyably recognized as the computer operator, i.e. the game player, while running the program. A digital camera, with supporting program software and memory, is conveniently incorporated in the top face of the game pad or computer keyboard to be easily positioned and triggered by the game player to capture the facial image of the game player or any other object, a pet animal or particular pictured image to be inserted on the character profile in place of a default facial image. Each game player also selects other body appearance options for adaptation into the game character. The computing device accepts and saves the character for immediate or later date game play action.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates to the image display of a computer operator in a computer program. More specifically, the present invention provides a method to insert the pictured appearance of the computer operator in a computer program such as a computer game or instructional program.

2. Description of the Prior Art

Companies in the business of designing and marketing games have always recognized that people will buy and enjoy more those products that are associated with people, places or activities they want or admire with engaging play action. Consequently, games are advertised depicting athletes, couples or big happy families excelling in their sport or having fun to increase the game appeal and entertainment value. These associations are to include the customer as a player and project what the player might wish to be: active, smart, successful and sociable. MILTON BRADLEY, a manufacturer of the well known board games such as THE GAME OF LIFE, RISK, YAHTZEE, PARCHEESI and SCRABBLE, run television adds that feature a group of friends or a variation of the happy family immensely enjoying the game. Many would recognize the television advertisements for the game BATTLESHIP that shows two friendly people engaged in the game with one claiming “You sank my battleship!”. The cover of the board game TWISTER shows a group of happy people seemingly ready to include another (customer) player.

By the mid 1970's, these simple board games were eclipsed by the ever increasing popularity of video games and improved pin ball machines found in the video arcade1 common to shopping malls. The backboard of pinball machines were updated with more flashing lights, sounds and scenes to encourage customers to play. These scenes were of well-known people of action and success often recognized from television or motion pictures the player wished to emulate. The pinball manufactures used this approach to retain customers against the more engaging video game. Personal computers loaded with computer games as engaging as the games found in the video arcades were not to be available until the early 1980's.

With the 1980's the video arcade fell into decline with the introduction of the interactive games and advancing technology offered on the computer game in the personal computer PC. The sophistication of computer and instructional games was limited only by the fast paced developing technology in computing power, memory storage and video display. Computer games, and video arcade games, quickly outgrew the simple versions of the gobbling PAC MAN and the point and click of MISSILE DEFENSE to much more visually stimulating and interactive designs. DOOM was a landmark game of the late 1980's that allowed up to four players to network and simultaneously move about, see and shoot the bad guys (and each other) in a harsh three-dimensional combat zone. The other players and monsters appeared as indistinct but recognizable characters mainly distinguished through color and size.

The 1990's brought an explosion of engaging computer games riding the advance in display resolution, computing power and memory capacity. NINTENDO CO. LTD. and SONY CORPORATION successfully marketed computer games played through specific purpose computers or game controllers that link with the common television for sound and picture. This approach brought gaming into the home at one-tenth the cost of a PC and featured a game pad for each player. These game pads provide the player with a fascinating array of buttons to control the game, far more interesting than the keyboard and an add-on joystick of the PC. These game controllers and computer games for the PC are at the forefront and are a large factor in advancing technology today. It is often the latest in game programs, not the text editor, that drives the customer to obtain the latest equipment to provide the rich graphics, smooth fast action and complicated interactive plots to maximize game play enjoyment.

Today, home computer games offer the user games and instructional programs that seem to be limited by the programmer's imagination rather than technology. The displayed color, motion and resolution of these systems support near life-like graphic images of well-known people and places. Some games mimic the look and feel being a player with the player's perspective in a baseball, football or soccer game. The other players are often recognized as real-life team players. It is this new level of sophisticated visual and complicated life-like interactive player involvement that engages the game player of today.

As exciting and interactive as today's computer programs and games are today, they do not include the ability for the computer user to easily and immediately capture a picture of, or any other object selected by, the computer user for integration and visual interaction with the computer program.

It is an object of this invention to provide the computer user the ability to go to the next step, to quickly and easily record the computer user's picture image with selection of other physical attributes to form an overall computer character for display within the program for a more enjoyable and engaging computer user experience through personal virtual interaction within the computer program.

### SUMMARY OF THE INVENTION

In view of the foregoing disadvantages inherent in the known types of game systems now present in the prior art, the present invention provides a new method and apparatus for inputting appearance of computer operator into a computer program construction wherein the same can be utilized for inserting the appearance of the computer operator in a computer program such as a computer game or instructional program.

The general purpose of the present invention, which will be described subsequently in greater detail, is to provide a new method and apparatus for inputting appearance of computer operator into a computer program that has many of the advantages of the game apparatus mentioned heretofore and many novel features that result in a new method and apparatus for inputting appearance of computer operator into a computer program which is not anticipated, rendered obvious, suggested, or even implied by any of the prior art game and computer apparatus, either alone or in any combination thereof.

The foregoing and additional objects are obtained by providing each computer operator the means to create an appearance character profile and insert the character image within the program for program activity i.e. game play. The computer operator is provided with the means to define a body type and immediately derive and add a facial picture to achieve an overall likeness ready for virtual action. This virtual self provides the computer operator with a more engaging experience because the operator can select how to interact in the virtual world in desirable situations with other known characters or other operators also within the program.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a method and apparatus for inputting appearance of computer operator into a computer program that will overcome the shortcomings of the prior art devices.

A second object is to provide a method and apparatus for inputting appearance of computer operator into a computer program for inserting the appearance of the computer operator in a computer program such as a computer game or instructional program.

Another object is to provide a method and apparatus for inputting appearance of computer operator into a computer program that conveniently captures the image of a computer operator.

An additional object is to provide a method and apparatus for inputting appearance of computer operator into a computer program that does not require the usage of an external camera to capture the image of a game player.

A further object is to provide a method and apparatus for inputting appearance of computer operator into a computer program that does not interfere with the normal operation of a game controller.

Another object is to provide a method and apparatus for inputting appearance of computer operator into a computer program that can be utilized with various types and styles of game controllers.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1A is a drawing of the preferred embodiment of the game pad modified with an integrated camera assembly.

FIG. 1B is a drawing of the modified game pad in perspective view to capture a picture of the computer operator.

FIG. 1C is a drawing of the modified game pad with respect to the camera and camera trigger.

FIG. 1D is an exploded view of the camera assembly for integration with the game pad.

FIG. 2 is a block diagram of the game pad camera.

FIG. 3 is an alternative embodiment of the invention of a computer keyboard with an integrated camera assembly.

FIG. 4 shows the steps to set-up the computer game with a character profile in accordance with the preferred embodiment of the invention.

FIG. 5 shows the picture preview of face alignment for picture capture.

FIG. 6 shows the selected character appearance based on the character profile.

### DESCRIPTION OF THE PREFERRED EMBODIMENT

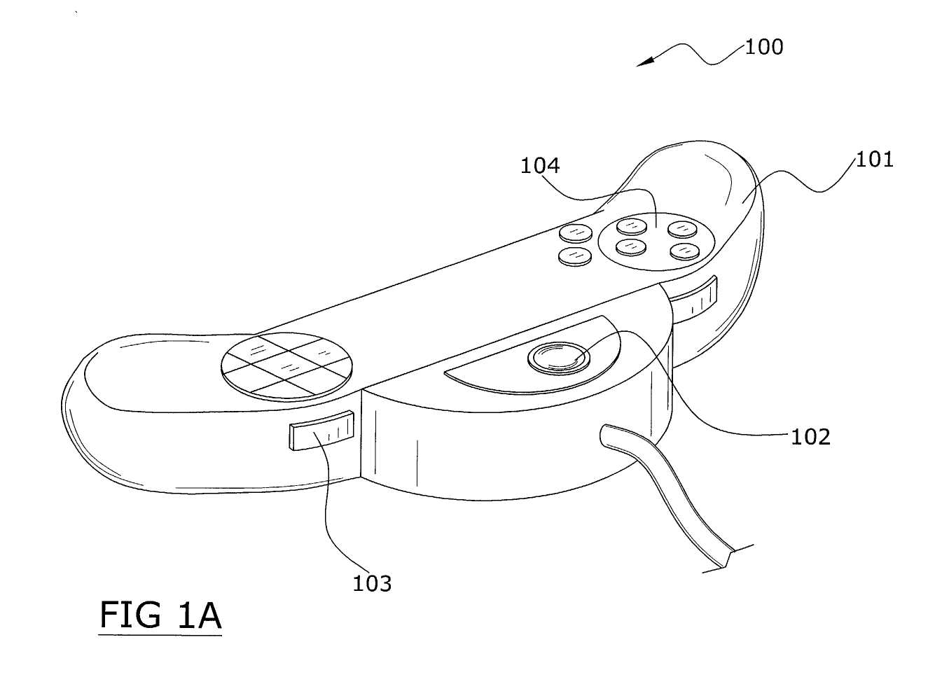

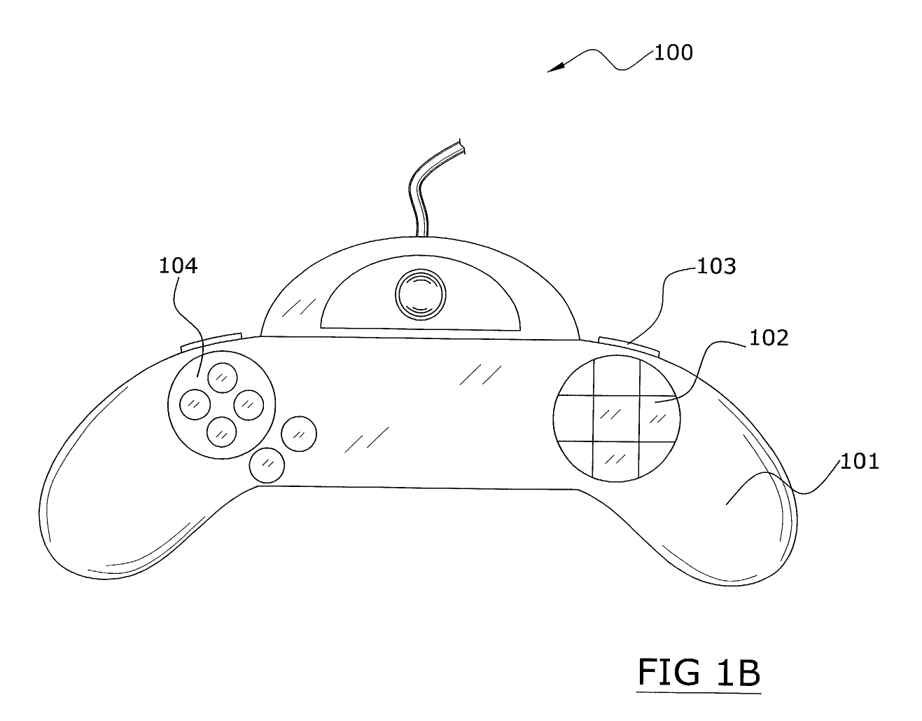

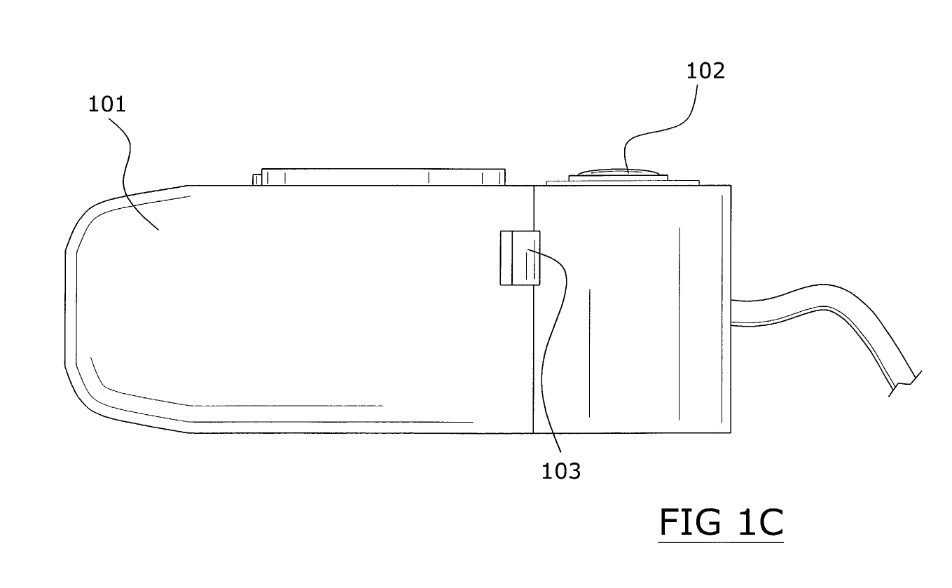

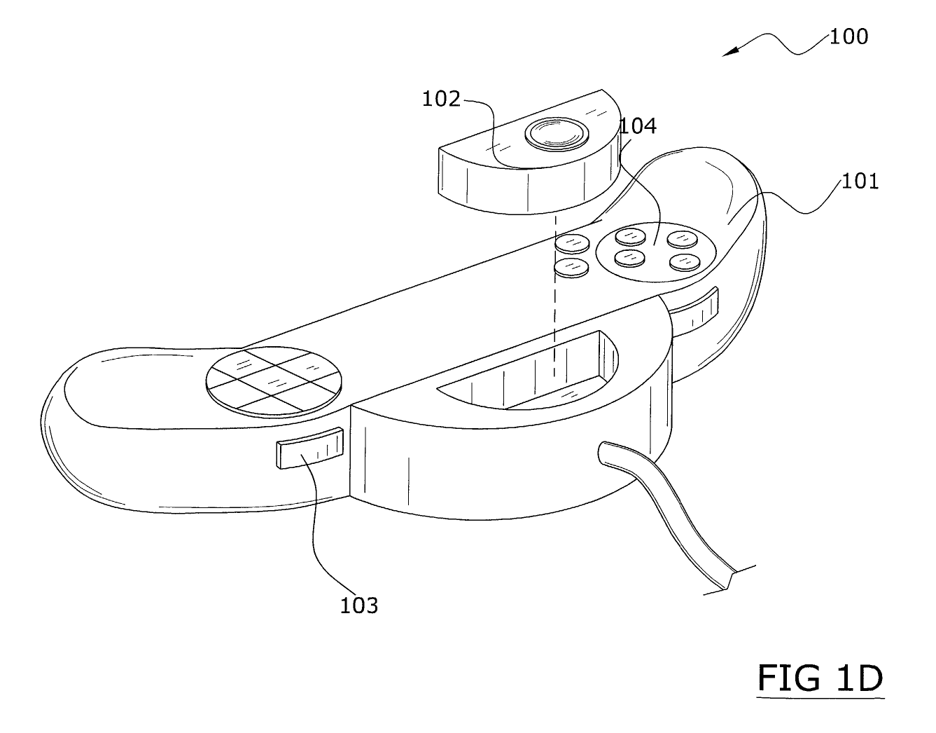

FIGS. 1A-1D are perspective views showing the external appearance of the typical game pad used by the game player to set-up and play a computer game in the preferred embodiment of the invention. FIG. 1A depicts the two handled game pad 101 intended to be held with both hands where the left hand buttons 104 are manipulated by the left thumb and forefinger and the right buttons 103, 105 are manipulated by the right hand thumb and forefinger. A camera assembly is positioned in the top front portion of the game pad where the lens is directed up. FIG. 1B shows the game pad from the perspective of the game player when the game pad is held in both hands in normal fashion. Note: that the camera assembly 102 is positioned so as to be easily aligned by the game player for a picture of self. At the appropriate point during the game set-up, the player is prompted to align the camera to view the player's face as seen on the game display to initiate or “take” a picture. It is preferred that the game pad user uses a right hand button 103 that is positioned advantageously under the right forefinger as highlighted in the perspective view of FIG. 1C. Other buttons would function similarly but without the convenience. FIG. 1D illustrates the inserted position of the camera assembly 102 into the game pad 101.

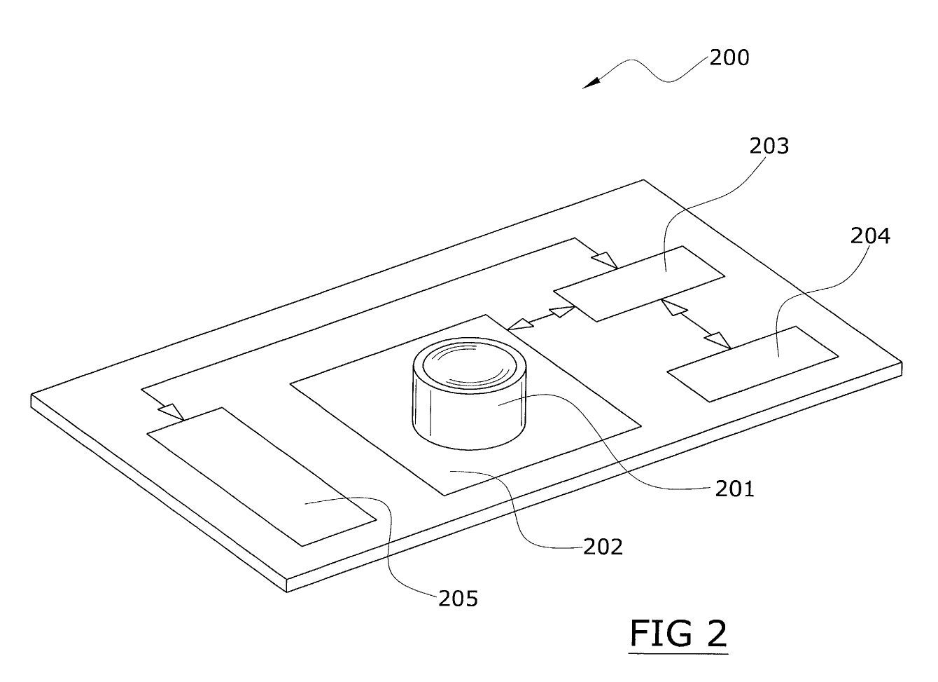

FIG. 2 depicts the main components in the digital camera assembly 200. The camera lens is positioned directly over the image sensor 202 to optically collect and focus the outside image onto the surface of the image sensor. A central processing unit (CPU) 203 manages the image data with processing support and image storage in the SRAM memory 204. The game program, commonly provided on a plug-in game cartridge to the game controller, would include code for the game controller to recognize and process the images provided by the camera assembly. A driver 205 is provided for the CPU to direct control information and to pass the collected image through the game pad to the game controller. The link uses a universal serial bus (USB) type communication protocol or other known protocol or configuration designated by the manufacturer of the game pad.

The technology for the digital camera assembly 200 is well known in the art where Intel Corporation and IBM make several similar device packages commonly known as the home PC camera. They connect through a USB port to the PC and are generally attached to the top of the PC monitor for a direct view of the computer operator. The cameras are supplied with software to configure the resident system. The camera program usually provides the ability to initiate a “snapshot” and storage as a .jpg, .bmp or .fpx file or to configure video streaming used in video conferencing. These PC camera units feature a focus field of 5 cm to infinity, automatic exposure control and VGA (640×480) resolution or higher depending on the associated image sensor. This VGA resolution is low as compared to high end cameras but is sufficient for images to be viewed on the computer monitor or with conversion, to television.

The image sensor 202 can utilize either of two types of image sensors: the charge-coupled device (CCD) or the complimentary metal-oxide semiconductor (CMOS). The CMOS version is less expensive since it is manufactured using the same process to build a microprocessor-integrated chip and consumes little power but the image is susceptible to noise and is of lower quality as compared to the CCD. The CCD produces high quality, low noise images and works well in low light but consumes many times the power of the CMOS type and is expensive to manufacture due to the special manufacturing process. In simple functional terms, both the CMOS and CCD image sensors have a two-dimensional array of thousands of tiny solar cells, each of which transforms the light from one small portion of the image into electrons but process the accumulated charge of each cell in the image differently. The details concerning the processing of the charges is beyond the scope of the invention but can found in company literature.

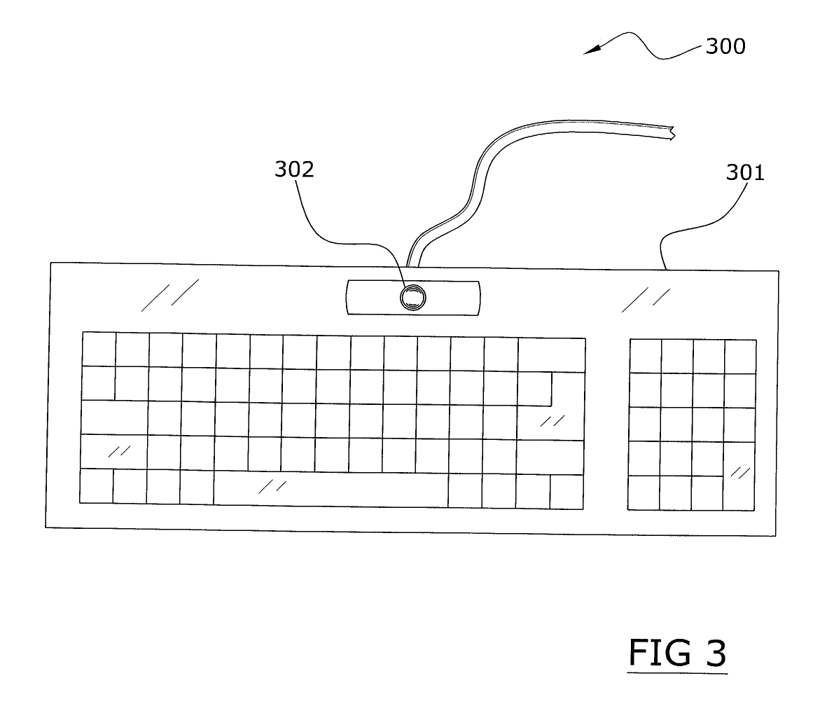

FIG. 3 shows a second embodiment of the invention 300 where the camera assembly 302 is integrated in a common personal computer keyboard 301. The camera assembly is positioned such that the lens points up and towards the expected facial position of the typical computer operator. This positioning facilitates the picture capture of the computer operator.

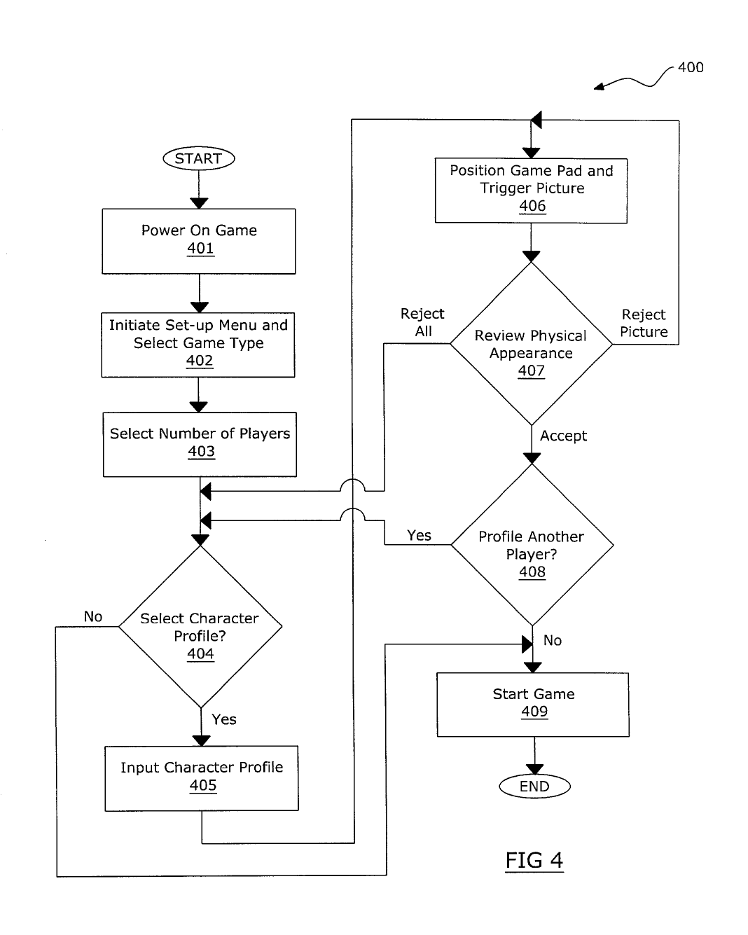

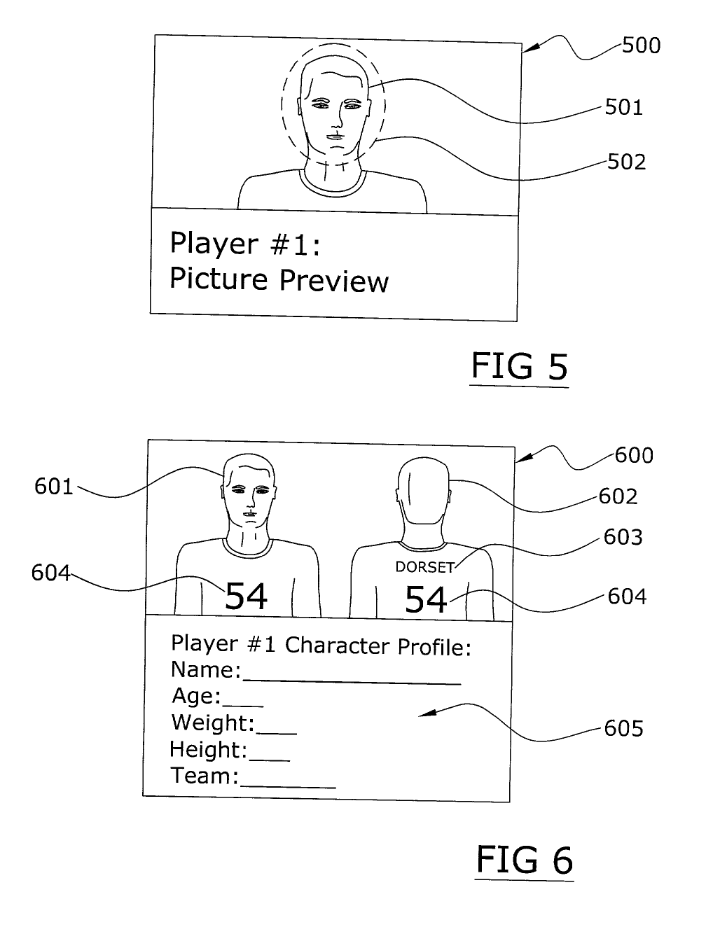

FIG. 4 shows the step-by-step process 400 of the preferred embodiment to set-up a game with the character profile selected by each game player. First, the game controller and television are powered on 401 and the lead or solo player (game set-up is generally under the control of player position #1 game pad) initiates the set-up menu and selects game type 402 and the number of players 403. Then, player #1 chooses to either select to character profile his game character, pass the option to any other player(s) to select to character profile their game character or, if there are no game characters to be selected to profile, start the game 409. With election to character profile a game character, the game player is prompted on the game set-up page to input various parameters 405 to build the character. In general, the player inputs the character name (his own), team name, player number, weight, height and nationality. The game accepts these inputs to generate the character's general appearance. The next step is to capture a picture of the game player's face 406. The player is prompted to position the game pad such that an image of the game player's face is centered within and fills in the designated area marked in the picture preview display page as shown in FIG. 5.

FIG. 5 shows the correct positioning of the player's image 500 as shown by the game display prior to engaging the predefined game pad button as discussed for FIG. 1B. The correct position is achieved when the player positions the camera equipped game pad of FIGS. 1A-1D at the proper angle and distance from the head region of the game player such that the image 501 just fills the target oval 502 presented on the game display. The camera assembly is designed and placed in the game pad to facilitate easy game pad positioning in the hands of the game player.

The next step in FIG. 4 is to review 407 the combined facial picture and game character body appearance as shown in FIG. 6. FIG. 6 shows the game set-up program display 600 of the character profile results based on the input parameters and facial picture input by the game player. The game character front 601 and rear view 602 is presented with the corresponding character profile parameters listed below. The general body type and correct style clothing is shown consistent with the input data and the type game selected and, as shown in the case of a soccer game, the correct jersey 603, player number 604 etc. are combined for review.

With review 407, game player decides to a) reject the pasted facial picture and return to the picture step, b) reject the entire appearance combination and return to the step to select the character profile or c) accept the appearance of the game character and save the character profile. The saved character profile would be available for recall for use during subsequent game play. With acceptance of the current character profile, the set-up menu prompts whether or not the next player selects a character profile (or accepts the default game character). Finally, after all the game players have completed their selections, the game is started 408. The game controller would use a method well known in the art to animate the profile character in place of the default game character image. The game players control the game characters through manipulation of the game pad surface controls in a manner well known in the art.

It is a second embodiment of this invention to utilize the camera assembly equipped keyboard of FIG. 3 for use with a personal, business or similar computer where the keyboard functions in the normal fashion with the additional feature of the built in digital camera assembly. In this arrangement, the computer operator would also utilize the camera assembly and software to insert a picture likeness of the computer operator within the compatible game, instructional or other appropriate program. The PC system has the advantage to load a run other type game programs or other type programs not compatible with the special purpose game systems, DREAMCAST, SONY PLAYSTATION and NINTENDO 64, previously discussed. For example, children could enjoy seeing themselves in instructional programs that would encourage learning.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method for selecting the appearance of a computer program character by a computer operator, said method comprising the steps of:
a) initiating program selection and program set-up menu;
b) selecting the number of characters for character profile;
c) inputting a character profile;
d) capturing an image;
e) combining the captured image with a character profile,
f) incorporating the character profile within the program; and
g) operating the computer program.

2. The method of claim 1 where said initiating, selecting, inputting, capturing and running is provided to the computer operator through an operator input board.

3. The method of claim 2 wherein said input board further comprises a camera.

4. The method of claim 3 wherein said camera is a digital camera.

5. The method of claim 3 wherein said capturing an image further comprises:
directing said input board for said camera to view a selected image; and
pressing a button on the input board to record a fixed image of the view.

6. The method of claim 5 wherein said selected image comprises the face of the program operator.

7. The method of claim 1 wherein said computer program is a computer game and said computer operator is a game player.

8. The method of claim 1 wherein said computer program is an instructional program.

9. The method of claim 1 wherein said input board comprises a game pad or computer keyboard.

10. The method of claim 1 wherein said incorporating further comprises animating the character profile.

11. The method of claim 1 wherein said incorporating further comprises storage of the character profile in memory for later use.

12. The method of claim 1 wherein said running the program comprises viewing and manipulating the character profile in said computer program.

13. A video game player image capturing apparatus, comprising:
a controller unit having a housing;
a plurality of control buttons within said housing;
an operator input board positioned within said controller unit and in communication with a computer game unit; and
a still image digital camera positioned within said controller unit and in communication with said operator input board for capturing the image of a game operator.

14. The video game player image capturing apparatus of claim 13, wherein still image digital camera has a lens facing in a direction of a face of said game operator while said game operator grasps said controller unit.

15. The video game player image capturing apparatus of claim 13, wherein said still image digital camera is positioned within a front middle portion of said housing of said controller unit.
